(19) United States
(12) Patent Application Publication
(10) Pub. No.: US 2025/0125684 A1
(43) Pub. Date: Apr. 17, 2025

(54) POWER GENERATING CHAIR

(71) Applicants: Gavin Ferro, Minnetonka, MN (US); Lucian Pier, Minneapolis, MN (US); Fiona Marie Motzenbecker, Minneapolis, MN (US)

(72) Inventors: Gavin Ferro, Minnetonka, MN (US); Lucian Pier, Minneapolis, MN (US); Fiona Marie Motzenbecker, Minneapolis, MN (US)

(21) Appl. No.: 18/916,964

(22) Filed: Oct. 16, 2024

Related U.S. Application Data
(60) Provisional application No. 63/590,732, filed on Oct. 16, 2023.

(51) Int. Cl. H02K 7/18; A47C 7/00; A47C 7/72; H02K 7/116; H02K 11/00; H02K 11/04

(52) U.S. Cl. CPC H02K 7/1853; A47C 7/004; H02K 7/116; H02K 11/0094; H02K 11/04; A47C 7/72

(57) ABSTRACT

The present disclosure relates to an energy harvesting device. The energy harvesting device disclosed herein captures kinetic energy and transforms it into a renewable energy source. The device disclosed herein uses one, or one or more gears to power one, or one or more motors and store the captured energy in a rechargeable battery pack. The energy storage device may be mounted on, or integrated into an everyday office chair. The kinetic energy may be created by the rotation, fidgeting, or swiveling of the chair. The movement of the chair may turn the gears, powering the motor, and storing the energy for future use.

### CROSS-REFERENCE TO RELATED APPLICATION

This application claims the benefit of and priority to U.S. Application No. 63/590,732, filed on Oct. 16, 2023, entitled POWER GENERATING CHAIR, the disclosure of which is hereby incorporated by reference in its entirety.

### TECHNICAL FIELD

The present disclosure generally relates to harvesting kinetic energy. More particularly, embodiments of the present disclosure relate to using the harvested kinetic energy to produce renewable energy sources.

### BACKGROUND

Harvesting energy from renewable sources is a growing area of interest in many fields. The current means of producing energy create many problems—with the burning of fossil fuels leading to climate change, and air pollution.

Kinetic energy harvesting is the process of capturing and storing the energy generated by motion or movement. There are several ways to harvest kinetic energy, including piezoelectric materials, electromagnetic induction, and electrostatic generators. Piezoelectric materials generate an electrical charge when they are subjected to mechanical stress, while electromagnetic induction uses the principle of electromagnetic induction to convert mechanical energy into electrical energy.

One of the most common applications of kinetic energy harvesting is in wearable technology, where the movement of the wearer can be harnessed to power electronic devices. For example, piezoelectric materials can be embedded in the sole of a shoe or integrated into clothing, allowing the energy generated by the wearer's footsteps to be converted into electrical energy. This energy can then be used to power sensors, GPS devices, or even charge a smartphone, medical device, or other portable electronic device.

Many current applications require the use of another tool or wearable accessory which can be cumbersome. Another challenge is efficiently converting the harvested energy. There remains a need to capture wasted energy, and turn it into a usable, renewable energy source in a cost effective and efficient manner.

### SUMMARY

According to a first aspect described herein, an energy harvesting device may include a housing with a first end, and a second end. The first end of the housing may be longer than the second end of the housing, and both ends may run in a horizontal fashion. The energy harvesting device may use a motor, the motor having a first gear and a second gear. The motor may use a diode bridge to connect to a rechargeable battery pack which stores the harvested energy. In one embodiment, the motor may be situated between the first end and the second end of the housing. The first gear may be coupled to the first end of the housing, while the second gear rotatably couples to the first gear.

In some embodiments, the energy harvesting device may have one motor. In another embodiment, the energy harvesting device may have multiple motors, such as six motors arranged around a moving component, that can be connected in a series circuit, and may be engaged through individual gears to a central gear attached to a post of a chair.

In a second aspect, a method of harvesting kinetic energy may include creating an energy harvesting device, where the energy harvesting device includes a housing, one or more motors, one or more gears, a rechargeable battery pack, and a diode bridge. The housing of the energy harvesting may be positioned on the post of the chair. When the chair moves, or rotates, the one or more gears rotates the one or more motors. The rotating of the one or more motors generates electricity from the kinetic energy produced by rotating and moving the chair. The generated electricity may then be stored in the rechargeable battery pack. Once the electricity is stored in the rechargeable battery pack, the rechargeable battery pack may be used to power a portable device.

In a third aspect, an energy harvesting device, may include a housing assembly with two half-circle discs that are removably coupled to create a circle. The housing assembly may have a first end and a second end. Around the circumference of the housing assembly, there may be two or more apertures, along with a central aperture. The second end of the housing may have two or more clamps that secure one or more legs of a chair to the housing. One or more motors may be attached or situated in the one or more apertures of the housing assembly, each of the one or more motors having a gear that may engage with a main gear located on the first end of the housing assembly. The energy harvesting device may further include a rechargeable battery pack and a diode bridge to aid in harvesting the kinetic energy and transporting it to the rechargeable battery pack.

In one embodiment, a post of the chair may pass through the central aperture, and the one or more legs of the chair may be connected to the energy harvesting device by the one or more clamps on the second end of the housing.

### BRIEF DESCRIPTION OF THE DRAWINGS

Subject matter hereof may be more completely understood in consideration of the following detailed description of various embodiments in connection with the accompanying figures, in which:

FIG. 1 is a perspective view of an embodiment of an energy harvesting device with a single motor.

FIG. 2 is a perspective view of an embodiment of a disassembled energy capture and storage feature of the present disclosure.

FIG. 3 is an exploded view of an embodiment of a diode bridge.

FIG. 4 is a perspective view of an embodiment of the energy harvesting device mounted on a chair post.

FIG. 5 is a perspective view of an embodiment of an energy harvesting device with six motors.

FIG. 6 is a perspective view of an embodiment of a housing assembly for the energy harvesting device with six motors.

FIG. 7A is a top view of an embodiment of a housing assembly for the energy harvesting device with six motors.

FIG. 7B is a bottom view of an embodiment of a housing assembly for the energy harvesting device with six motors.

FIG. 8A is a cross-sectional top view of an embodiment of a housing assembly for the energy harvesting device with six motors.

FIG. 8B is a cross-sectional bottom view of an embodiment of a housing assembly for the energy harvesting device with six motors.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

There is therefore a need for a device to capture wasted energy, and turn it into a usable, renewable energy source in a cost effective and efficient manner. There is also a need for a solution to help resolve the growing energy crisis in simple, and common-sense approach. As described below, the present disclosure relates to converting random, kinetic motion, to DC motion, to electricity to be stored in a battery.

The present disclosure relates to an energy harvesting device. The energy harvesting device disclosed herein captures kinetic energy and transforms it into a renewable energy source. Some applications may use a diode bridge.

An advantage of using a diode bridge for energy harvesting is that it is a simple and inexpensive device that can be easily integrated into different applications. Additionally, it can be used with a wide range of sources such as solar panels, electromagnetic fields, and even vibration energy harvesters. This versatility makes it a popular choice for many energy harvesting applications, from wireless sensors to smart homes and even electric vehicles. However, creating an energy harvesting device that successfully transfers the harvested energy, to a renewable source such as a rechargeable battery, has not seen great success in daily application.

The device disclosed herein uses one or one or more gears attached to moving components to drive one or more motors and store the captured energy in a rechargeable battery pack. The energy storage device may be mounted on, or integrated into an everyday office chair. The kinetic energy may be created by the rotation, fidgeting, or swiveling of the chair. The movement of the chair may turn the gears, powering the motor, and storing the energy for future use.

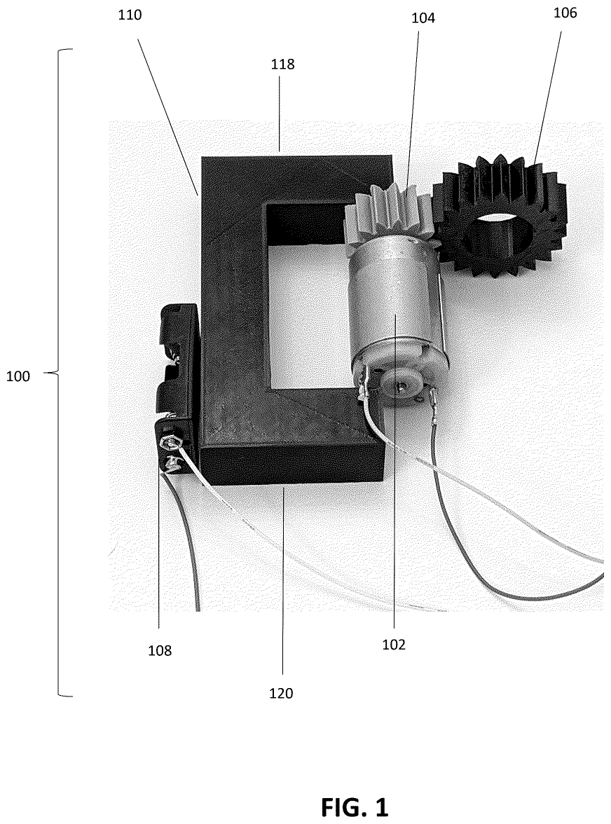

Referring now to FIG. 1, an embodiment of an energy harvesting device with a single motor. The energy harvesting device 100 may have a housing 110. The housing 110 may have a first end 118, and a second end 120 separated from another in an axial direction, wherein the first end 118 is longer in length than the second end 120. The length difference facilitates a better fit when the housing 110 is mounted or attached to a chair. Situated between the first end 118 and the second end 120 of the housing 110, is a motor 102. The motor 102 may have a first gear 104 that attaches to the first end 118 of the housing 110. A second gear 106 is rotatably coupled to the first gear 104. On an external surface of the housing, a rechargeable battery pack 108 may be mounted.

While the motor 102 is arranged between the first and second ends 118 and 120 in the embodiment shown in FIG. 1, the motor could be integral with the first end 118, or could be arranged on the opposite side of first end 118 from the second end 120 in a stacked arrangement.

In one embodiment, the energy harvesting device 100 may be mounted on a chair using the housing 110. The housing 110 may be removably attached to the post of a chair. The housing 110 may be mounted at any position on the post of the chair, but in one embodiment, the housing 110 may be mounted on the lower half of the post, near the legs of the chair. This may facilitate a more stable attachment. The housing 110 does not inhibit rotation of the chair. Rather, as the chair rotates or spins on the post, the first gear 104, rotates the second gear 106, which then turns the motor 102. This process generates power from the kinetic energy produced by the chairs movement, which then is transformed to electricity to be stored in the rechargeable battery pack 108.

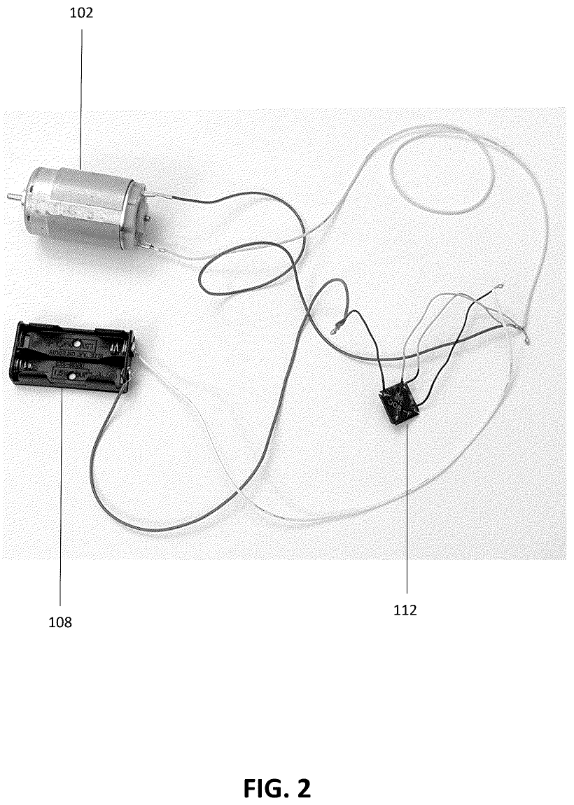

Referring now to FIG. 2 an embodiment of an energy capture and storage feature of the present disclosure. The energy capture and storage of the present disclosure may include a motor 102, which captures kinetic energy, a diode bridge 112 that is able to store the energy generated in both directions, and a rechargeable battery pack 108. The motor 102 may be attached to the housing 110 of FIG. 1, the motor 102 may connect to the diode bridge 112 via cables. The diode bridge 112 connects to the rechargeable battery pack 108 where the harvested energy may be stored and later used.

In another embodiment, the energy harvesting device 100 may have more than one motor 102. An optional embodiment may include an individual rechargeable battery pack 108 for each motor 102 that is used. If more than one rechargeable battery pack 108 is used, each rechargeable battery pack 108 will require an individual diode bridge 112. In this embodiment, the power that is captured and stored would be spread across multiple rechargeable battery packs 108, which may allow for more portable devices to be charged with the rechargeable battery pack 108.

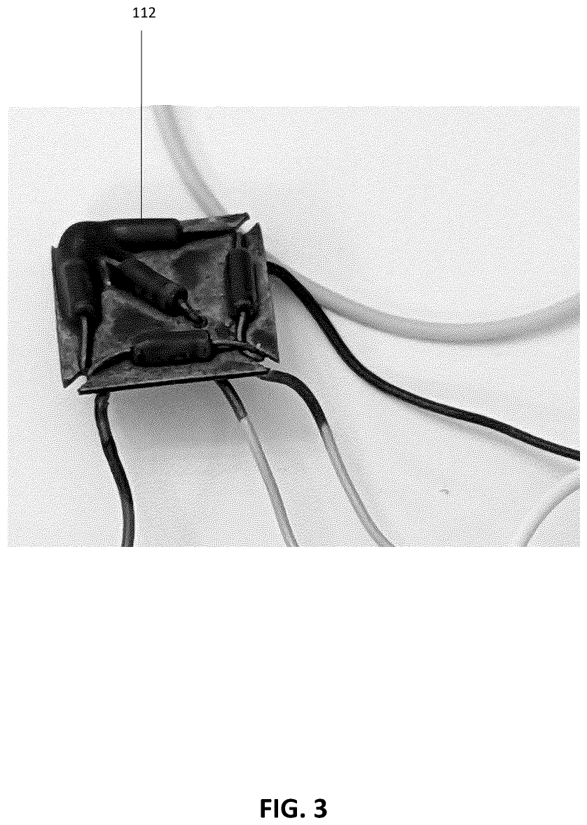

Referring now to FIG. 3 a diode bridge is shown that is usable in embodiments described herein. The diode bridge 112 is used to convert the AC power that is produced from one direction of motion to DC power so that multiple directions of motion can be converted to usable energy to be stored. Therefore, energy generated as the chair is rotated in either direction may be stored and used in the rechargeable battery pack 108. Chairs often spin in both counterclockwise and clockwise directions, requiring more than an AC motor. The use of the diode bridge 112 captures more kinetic energy for storage in the rechargeable battery pack 108, and for later use.

The diode bridge 112 is a device that is commonly used to convert alternating current (AC) into direct current (DC). It is made up of four individual diodes that are arranged in a specific way to ensure that current flows in only one direction. When used for energy harvesting, the diode bridge acts as a rectifier, converting the AC voltage produced by the source (in the present disclosure, the movement of the chair) into DC voltage that can be used to power various portable devices. The diode bridge 112 works by allowing current to flow in only one direction. When the AC voltage is positive, current flows through one set of diodes, and when the AC voltage is negative, current flows through the other set of diodes. The resulting DC power is then left in a useable form to be stored in the rechargeable battery pack 108, and used to power or charge wireless headsets, smartphones, tablets, and various other wireless portable devices.

The diode bridge 112 acts to prevent backflow of electricity by engaging the AC current. This allows the generated energy from the chair, to be harvested and stored in the rechargeable battery pack 108 that can be used for a phone, laptop, wireless headset, wireless mouse, wireless keyboard, or another portable electronic device that requires charging or energy. Multiple rechargeable battery packs 108 may be used in an embodiment, and each of the rechargeable battery packs 108 may have an individual diode bridge 112 attached. The diode bridge 112 may also serve the secondary purpose of preventing the motor 102 from needing to be being powered.

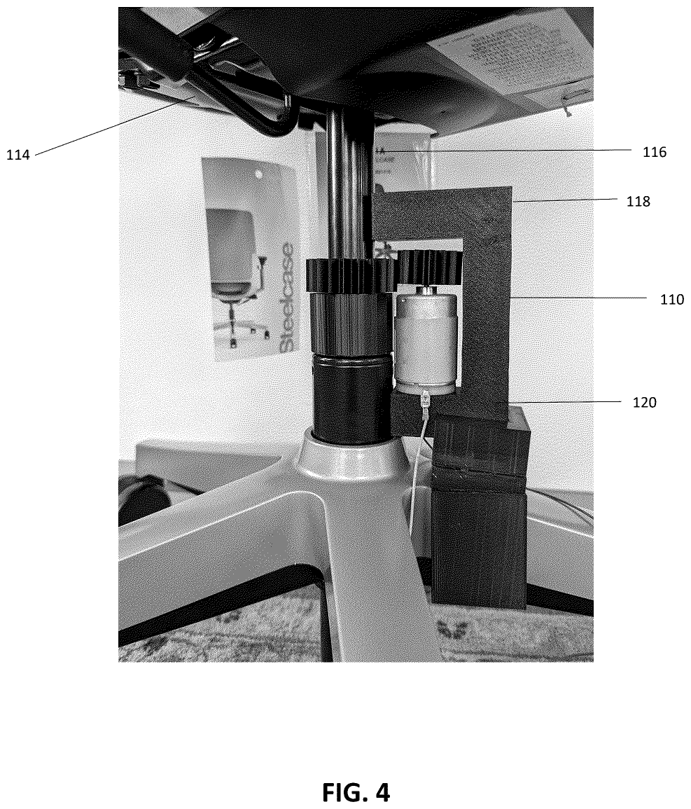

Referring now to FIG. 4 an embodiment of the energy harvesting device mounted on a chair post. The housing 110 of the energy storage device 100 may be mounted to the side of a chair 114. The first end 118 that may be longer in length than the second end 120, enables the housing 110 to properly mount to a chair post 116 of the chair 114. The bottom of the chair 114 may have a reinforcement that increases the diameter of the chair post 116, such that the second end 120 of the housing 110 is shorter to compensate in this embodiment.

In one embodiment, the chair 114 may be an office chair that is capable of spinning, rotating, or swiveling on the post 116 of the chair 114. The chair 114 may also have features that enable it to be raised or lowered depending on the preference of the user. Additional or different features may slightly alter the shape or configuration of the housing, though, additional embodiments are contemplated by the disclosure herein. In another embodiment, the first end 118 and the second end 120 may be the same length. In yet another embodiment, the first end 118 may be shorter in length than the second end 120.

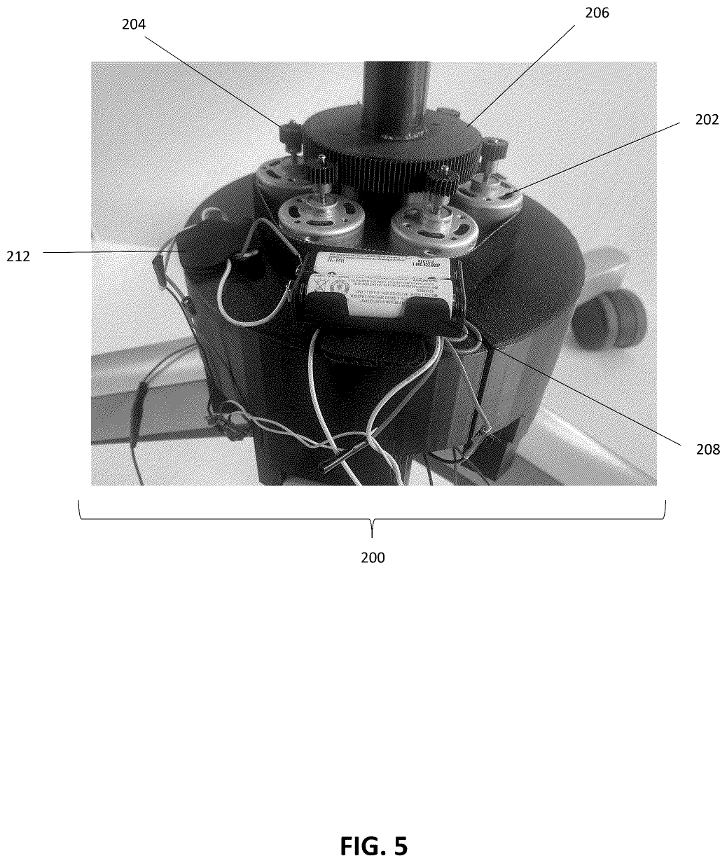

Referring now to FIG. 5 an embodiment of an energy harvesting device with six motors. The energy harvesting device 200 may have one or more motors 202. Each of the one or more motors 202 may have one or more gears 204, that interact and are rotatably coupled to a main gear 206. Attached to a strap on a housing of the energy harvesting device 200 are a rechargeable battery pack 208 and a diode bridge 212.

In one embodiment, the one or more motors 202 includes six motors, and the one or more gears 204 includes six gears. Each of the one or more motors 204, may have one of the one or more gears 204 attached to it. When a chair rotates, swivels, or spins, the one or more gears 204 turn, and spin or rotate the main gear 206. This action powers the one or more motors 202, and the power created may be transformed into electricity which is captured by the diode bridge 212 and stored in the rechargeable battery pack 208.

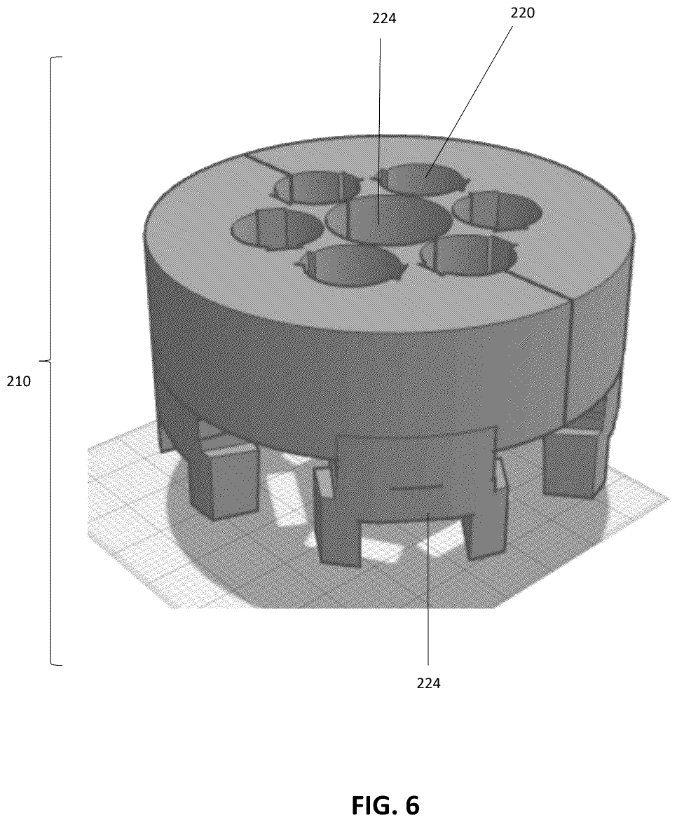

Referring now to FIG. 6 an embodiment of a housing assembly for the energy harvesting device with six motors. The housing 210 may be circular in shape and nature. The housing 210 may include two half-circles that are removably coupled to create the housing 210. The housing 210 may have a central aperture 224, through which a chair post may pass. The housing 210 may also have one or more apertures 220 around the circumference of the housing 210. The housing may also have one or more clamps 218 that attached to one or more legs of a chair.

In one embodiment, the amount of motors may be any number desired for the amount of energy desired to be captured. In one embodiment, there may be two motors, or three motors, or four motors, or five motors. For every additional motor, the one or more apertures 220 can increase or decrease in number to accommodate.

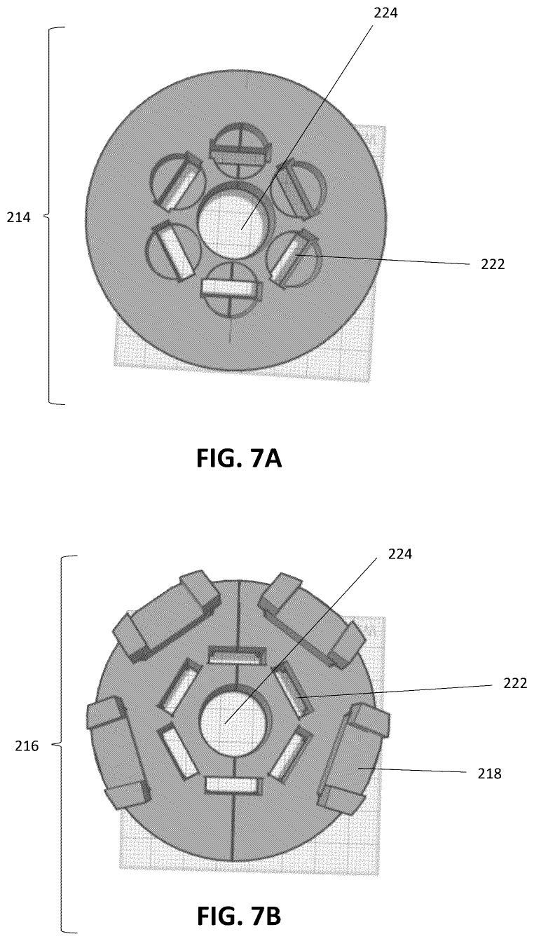

Referring now to FIGS. 7A and 7B, a top view and a bottom view of an embodiment of a housing assembly for the energy harvesting device with six motors. FIG. 7A is a top view of an embodiment of a housing assembly for the energy harvesting device. The top of the housing 210 may have a first side 214. The first end 214 may have a central aperture 224, and one or more slots 222. The one or more slots 222 allow the wires from the one or more motors 202 to pass through the housing 210. FIG. 7B is a bottom view of an embodiment of a housing assembly for the energy harvesting device. The bottom of the housing 210 may have a second side 216. The second end 216 may have a central aperture 224, one or more slots 222, and one or more clamps 218. The one or more slots 222 allow the wires from the one or more motors 202 to pass through the housing 210. The one or more clamps 218 may allow for the housing 210 to be attached to one or more legs of a chair.

The circumference of the disc may vary based on the size of the chair. Further, the diameter of the central aperture may vary based on the size of the post 216 of the chair 214. The energy harvesting device 200 will function on a variety of different chairs 214 of different sizes, configurations, and designs. Further, the energy harvesting device 200 may be attached to different areas of the chair based on the desired motion to capture energy from.

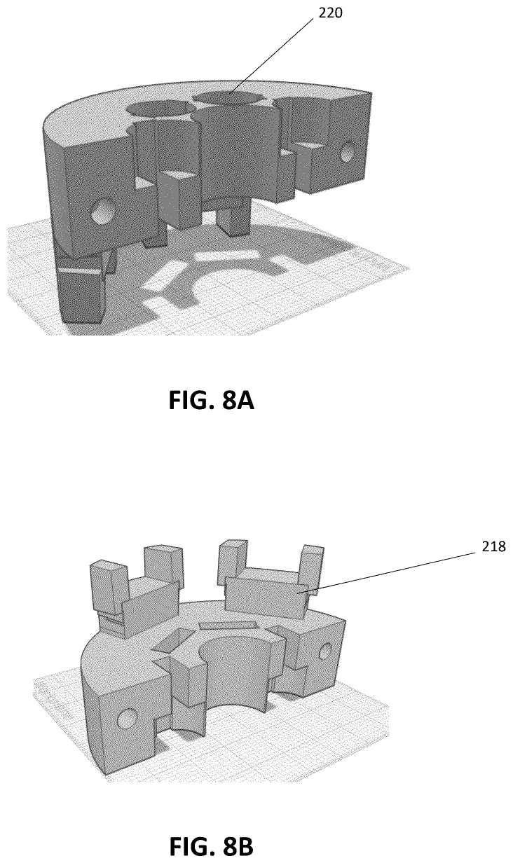

Referring now to FIGS. 8A and 8B a cross-sectional top view, and a cross sectional bottom view of an embodiment of a housing assembly for the energy harvesting device with six motors. FIG. 8A illustrates a cross-sectional top view of a first side 214 of the housing 210. The first side 214 may have one or more apertures 220 around the circumference of the housing 210. FIG. 8B illustrates a cross-sectional bottom view of a second side 216 of the housing 210. The second side 216 of the housing may have one or more clamps 218. The one or more clamps allow the housing to be situated on or attach to one or more legs of a chair.

When assembled, the energy harvesting device 100 or 200 may be mounted on or integrated into a chair 214. In an embodiment, the energy harvesting device 100 or 200 may be a separate component that is later attached to the chair 214. The energy harvesting device 100 or 200 may include a housing 110 and 210, and the housing 110 and 210 is the portion of the energy harvesting device 100 or 200 that will be attached or integrated into the chair 214. On the housing 110 and 210, there may be a motor 102, or one or more motors 202. On the motor 102 or the one or more motors 202, there may be a first gear 104, or one or more gears 204 attached to the motor 102 or the one or more motors.

The first gear 104 on the motor 102 may be rotatably coupled to a second gear 106. In another embodiment, the one or more gears 204 may interact with a main gear 206. In each embodiment, the rotation of the first gear 104 or the one or more gears 204, in turn moves the second gear 106, or the main gear 206, which powers the motor 102 by driving the rotation of the motor or the one or more motors 202.

In another embodiment, and as seen in FIG. 5, a band may be used to hold the one or more motors 202 in place on the housing 210. The housing 210 itself may be attached around the post 216 of the chair 214. Each of the disks of the housing 210 may be separated to encircle the post 216 of the chair 214.

In one embodiment, the housing 110 may have a first end 122 and a second end 124, with the first end 122 being longer in length than the second end 124. The longer length may aid in holding a motor 102 in place on the housing 110. Further, the difference in length allows the housing 110 to be mounted on a post or leg of a chair 114, even while the chair 114 has the ability to be raised or lowered.

In use, movement in the chair (rotation, fidgeting, or other motion), engages the main gear 206, that interacts with one or more gears 204, which in turn, rotate the one or more motors 202. The rotation of the one or more motors 202 generates electricity to be stored in the battery pack 208, each time the chair 214 is rotated or turned. The stored energy in the rechargeable battery pack 208 may be used to power a portable device. The rechargeable battery pack 208 may be portable, and disconnected from the cables attaching it to the diode bridge 212. The rechargeable battery pack 208 may then be reconnected to the diode bridge 212 for future energy capture and storage.

In another embodiment, the movement in the chair (rotation, fidgeting, or other clockwise or counter-clockwise motion), engages the first gear 104, which rotates the second gear 106, powering the motor 102. The rotation of the motor 102 generates electricity to be stored in the battery pack 108, each time the chair 214 is rotated, or turned. The stored energy in the rechargeable battery pack 108 may be used to power a portable device. The rechargeable battery pack 108 may be portable, and disconnected from the cables attaching it to the diode bridge 112. The rechargeable battery pack 108 may then be reconnected to the diode bridge 112 for future energy capture and storage.

In one embodiment, the housing 110 and 210 of the energy harvesting device 100 and the energy harvesting device 200 may be formed by a method of 3D modeling and printing. The housing 110 and 210 may be made of any material that is reasonably strong, and reasonable firm to securely mount or attach to the chair 214.

In another embodiment, the housing 110 and 210 may be formed by injection molding or extrusion methods. In each method of creating the housing 110 and 210, the shape and features of the housing 110 and 210 will still be present. In embodiments, the relative size, number of motors 102 and 202, and the number of gears 104 and 204 may change depending on the desired amount of power to be produced and collected, as well as the design of the chair that the energy harvesting device 100 and 200 may be mounted on.

The present disclosure may use a diode bridge. If the chair were only to move or rotate in a single direction, a DC motor could be used, but because chairs often rotate in clockwise and counterclockwise directions, AC power is produced, requiring that the power be converted to DC so that it can be stored. This way, the energy generated in both directions may be stored and used in the rechargeable battery pack.

A diode bridge is a device that is commonly used to convert alternating current (AC) into direct current (DC). It is made up of four diodes that are arranged in a specific way to ensure that current flows in only one direction. However, a diode bridge can also be used to harvest energy from different sources such as solar panels or electromagnetic fields. When used for energy harvesting, the diode bridge acts as a rectifier, converting the AC voltage produced by the source into DC voltage that can be used to power electronic devices.

The diode bridge works by allowing current to flow in only one direction. When the AC voltage is positive, current flows through one set of diodes, and when the AC voltage is negative, current flows through the other set of diodes. This process produces a pulsating DC voltage that can be smoothed out using a capacitor. The resulting DC voltage can then be used to power electronic devices, charge batteries, or even feed back into the grid.

The diode bridge acts to prevent backflow of electricity by engaging the AC current. This allows the generated energy from the chair, to be harvested and stored in a portable battery pack that can be used for a phone, laptop, wireless headset, wireless mouse, wireless keyboard, or another portable electronic device that requires charging or energy.

While the term “housing” has been used herein, the housing may be any structure that fits the following criteria: the housing extends in an axial direction and has a first end and a second end. The first end and the second end of the housing extend parallel to one another from the housing in a direction that is perpendicular to the axial direction. In one embodiment, the first end is longer than the second end. The housing may hold or support various components of the energy harvesting device, such as the one or more motors. In addition, the one or more gears may be mounted to the first end of the housing.

In another embodiment of the present disclosure, the term “housing” may be used to describe the support for an energy harvesting device having multiple motors. In this embodiment, the housing may be circular, and have one or more apertures to securely support the one or more motors. In each embodiment disclosed herein, the housing need not completely enclose or surround the components it attaches to or supports. However, in another embodiment, the components, including the one or more motors, the diode bridge, the one or more gears, and the rechargeable battery pack, may be enclosed by the housing, with the housing being the external support for the previously listed internal components.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Any incorporation by reference of documents above is limited such that no subject matter is incorporated that is contrary to the explicit disclosure herein.

Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

What is claimed is:

1. An energy harvesting device, comprising:
a housing extending in an axial direction, the housing having a first end and a second end extending parallel to one another from the housing in a direction perpendicular to the axial direction, wherein the first end is longer than the second end;
a motor arranged to generate an electrical current using a rotational movement of an adjacent shaft;
a rechargeable battery pack; and
a diode bridge connected to the motor to convert the electrical current to a DC current and deliver the DC current to the rechargeable battery pack;
wherein the motor is at the first end of the housing and mechanically coupled to the adjacent shaft.

2. The energy harvesting device of claim 1, wherein the housing is mounted to a post of a chair.

3. The energy harvesting device of claim 2, wherein an amount of energy harvested in a week's time is collected in the rechargeable battery pack.

4. The energy harvesting device of claim 1, wherein the rechargeable battery pack is used to power a smart phone, a laptop, a tablet, a wireless headset, a wireless mouse, or a wireless keyboard.

5. The energy harvesting device of claim 1, wherein the housing is integrated into a post of a chair.

6. The energy harvesting device of claim 1, further comprising a first gear coupled to the motor and a second gear arranged around the adjacent shaft, the second gear coupled to the first gear such that rotation of the adjacent shaft drives the motor.

7. The energy harvesting device of claim 6, wherein the rotation of the adjacent shaft driving the motor, harvesting kinetic energy.

8. The energy harvesting device of claim 1, wherein the rechargeable battery pack is coupled to an exterior surface of the housing.

9. A method of harvesting kinetic energy, the method comprising:
creating an energy harvesting device, the energy harvesting device comprising a housing, one or more motors, one or more gears, a rechargeable battery pack, and a diode bridge;
positioning the housing of the energy harvesting device on a post of a chair;
rotating or moving the chair to engage the one or more gears, which drives the one or more motors;
generating electricity from kinetic energy produced by the rotating and moving of the chair;
storing the generated electricity in the rechargeable battery pack; and
using the stored generated electricity in the rechargeable battery pack to power a portable device.

10. The method of claim 9, wherein the energy harvesting device is integrated into the post of the chair.

11. The method of claim 9, wherein the portable device is a smart phone, a laptop, a tablet, a wireless headset, a wireless mouse, or a wireless keyboard.

12. The method of claim 9, further comprising recharging the rechargeable battery pack by returning it to the energy harvesting device.

13. The method of claim 9, wherein the one or motors are present in an amount of six motors.

14. The method of claim 13, wherein the one or more gears are present in an amount of six gears, with a main gear being connected to the housing.

15. The method of claim 9, wherein more than one rechargeable battery pack is used, and each of the rechargeable battery packs uses an individual diode bridge.

16. An energy harvesting device, comprising:
a housing assembly including two half-circle discs that are removably coupled to create a circle, the housing assembly having a first end and a second end, with two or more apertures around a circumference of the housing assembly, and a central aperture;
the second end of the housing having two or more clamps to secure one or more legs of a chair to the housing; and
one or more motors, each of the one or more motors having a gear which engages with a main gear located on the first end of the housing assembly,
a rechargeable battery pack; and
a diode bridge;
wherein the one or more motors are situated within the two or more apertures around the circumference of the housing assembly, with the rechargeable battery pack and the diode bridge being connected to a surface of the housing assembly, and a post of a chair passing through the central aperture, the one or more legs of the chair being connected to the energy harvesting device by the one or more clamps on the second end of the housing.

17. The energy harvesting device of claim 16, wherein the one or more motors are present in a total of six motors.

18. The energy harvesting device of claim 16, wherein the two or more apertures are present in a total of 6 apertures.

19. The energy harvesting device of claim 16, further comprising a strap to hold the one or more motors securely in place on the housing assembly.

20. The energy harvesting device of claim 16, wherein the energy harvesting device is integrated into the chair.
